(19) United States
(12) Patent Application Publication
(10) Pub. No.: US 2017/0243253 A1
(43) Pub. Date: Aug. 24, 2017

(54) ADVERTISEMENT EXCHANGE NETWORK

(71) Applicant: Thomas DeBacco, Baltimore, MD (US)

(72) Inventor: Thomas DeBacco, Baltimore, MD (US)

(21) Appl. No.: 15/052,708

(22) Filed: Feb. 24, 2016

(51) Int. Cl. G06Q 30/02; G06Q 20/20; G06K 7/14

(52) U.S. Cl. CPC G06Q 30/0268; G06K 7/1417; G06Q 20/209

(57) ABSTRACT

The present invention is an advertising exchange network that allows users to dynamically print a receipt with an advertisement and any additional information from a standard point of sale terminal. The advertisement exchange network utilizes an intercept module (IM) that interconnects between the printer and point of sale system. Upon issuance of a print command by the point of sale terminal, the IM intercepts the print command and modifies the print command to add advertising in the form of images, text, coupons, barcodes, codes, advertising information, or the like. The IM then relays the new print command to the printer which will print the receipt, advertisements, and other pertinent information, as directed by the users of the advertisement exchange network. A credit system may also be utilized to encourage advertising and exposure of the participating members. The user may also search for and retrieve a copy of the receipt online.

### FIELD OF THE INVENTION

This invention generally relates to the field of advertising communications. In particular, the invention generally relates to improved systems for advertising in association with advertisement exchange networks, point of sales, and digital displays/televisions.

### BACKGROUND OF THE INVENTION

For decades, advertising has been used as a form of communication for businesses in order to persuade consumers to take some new action. Most commonly, the desired result of advertising is to drive consumer behavior with respect to a commercial offering. Advertising is typically performed by messages, which are usually paid for by sponsors, and are generally viewed through various traditional media such as newspaper, magazines, television commercials, radio advertisement, website banner ads, or direct mail.

In addition to traditional advertising, companies have been utilizing other forms of advertising by creating innovative techniques to increase public awareness. Examples of such include grocery store receipts. Grocery store receipts typically use advertisements and/or coupons on the back of receipts, and dynamic ads or coupons, which are printed on specialized printers based upon the purchases of a particular shopper's profile. Software has also been used on various point of sale terminals to augment new advertising information on receipts.

Unfortunately, existing advertising utilizing receipt space is somewhat limited. In the receipt world, advertisements would typically be pre-printed on the back of receipts and typically do not allow users to create and change advertisements in real time. Software used on point of sale terminals do not currently utilize advertisement exchange networks to facilitate the exchange of online advertising inventory. Furthermore, point of sale terminals do not currently use networks to encourage the distribution of advertisement information.

There are several references that disclose devices and methods for advertising communications. For example, U.S. Patent Application Publication No. 2003/0036979, filed by Mitsuhiro Tokorotani (“the Tokorotani reference”) discloses a system, method, and device for facilitating advertisement requests between an advertiser and a store running the advertisement. A server of the Tokorotani reference is connected to an advertiser terminal and a point of sale device through a network. The server registers request information and advertising content of the advertiser, and based upon the advertisement request information, the server selects a store that satisfies the requirement of the advertiser. The server then sends the associated advertising content to the point of sale device of the selected store; whereupon, the point of sale device stores and receives the advertising content and prints the stored advertising content onto a sales receipt.

Although the Tokorotani reference provided a mechanism that facilitates advertisement requests, it does not overcome the problem of allowing users to create and change ads in real time. This is a significant downside for advertisers in need of ad customization.

Additionally, other references, including U.S. Patent Application Publication No. 2009/0254428, filed by Jacob M. Sterling et al. (“the Sterling reference”) and U.S. Pat. No. 6,719,197 (“the '197 Patent”), disclose advertising systems utilizing a computer network and point of sale terminals that communicate and print advertising content. However, none of these references incorporate a device or method for creating and changing advertisements in real time. For example, the '197 Patent, issued to Torao Yajima discloses a system, apparatus, and method for issuing receipts and providing advertising. The system includes point of sale terminals that are equipped with an ink-jet printer with ink jet cartridges storing advertisement information. Once the ink jet cartridge is loaded onto a printer, advertisement information is generally read by the point of sale terminal and later printed onto a receipt. Indeed, the device, system, and method disclosed in the '197 Patent is extremely limited and does not allow a user to customize advertisements in real time. Additionally, the invention in the '197 Patent does not work with any point of sale terminal software and does not allow users to search, retrieve, and download copies of their receipt.

Therefore, what is needed is an advertising exchange network that provides the flexibility to create and change advertisements in real time, work with any point of sale terminal software, and allow users to search, retrieve, and view downloaded copies of their receipt.

### SUMMARY OF THE INVENTION

To minimize the limitations in the prior art, and to minimize other limitations that will become apparent upon reading and understanding the present specification, the present invention discloses an advertisement exchange network that allows users to create advertisements, coupons, and the like and distribute them on in a dynamic setting.

One embodiment of the present invention is an advertisement exchange network system, the network system comprising: a server; a database; a point of sale terminal; and a intercept module; wherein the server includes a web application; wherein the web application collects one or more instructions and one or more content from one or more users and updates the database with the one or more instructions and one or more content; wherein the database stores the one or more instructions and one or more content; wherein an algorithm optimizes distribution of the one or more content across a network based on the one or more instructions and a metadata stored in the database; wherein the server assigns one or more selected content and one or more selected instructions to the intercept module based on an output of the algorithm; wherein the one or more intercept modules download the one or more content and the one or more instructions as the one or more content and the one or more instructions are updated; wherein the point of sale terminal sends one or more print commands to a printer after performing a transaction; wherein the intercept module is interconnected between the point of sale terminal and the printer, such that the intercept module, emulates the functionality of the printer to receive the one or more print commands of said point of sale terminal; wherein said intercept module emulates the functionality of the point of sale terminal so that the printer will accept one or more incoming print commands and send status information; wherein the intercept module intercepts and parses the one or more print commands from the point of sale terminal; wherein the intercept module alters the one or more print commands based on the one or more instructions and content the intercept module received from the server; wherein the intercept module passes the one or more altered print commands to the printer; wherein the printer prints a receipt based on the one or more altered print commands The receipt may be comprise: a transaction information; one or more business advertisements or coupons; and one or more network advertisements. The web application may allow the one or more users to create and edit the one or more content, such that the receipt is customizable to the one or more users. The web application may allow the one or more users to configure and customize the output of the intercept module. The web application may allow the one or more users to view interact and exchange ads with one or more network nodes in an advertising exchange network; wherein the one or more network nodes comprises: at least one of the point of sale terminal, one printer and at least one of the intercept module. The intercept module may record and store both the one or more print commands and the one or more altered print commands received from said point of sale terminal. The intercept module may redirect the one or more print commands and the one or more altered print commands to another output medium such as email, mobile text message or any other output medium.

Another embodiment of the present invention is an advertisement exchange network system, the network system comprising: a server; a database; a point of sale terminal; and a intercept module; wherein the server includes a web application; wherein the web application collects one or more instructions and one or more content from one or more users and updates the database with the one or more instructions and one or more content; wherein the database stores the one or more instructions and one or more content; wherein an algorithm optimizes distribution of the one or more content across a network based on the one or more instructions and a metadata stored in the database; wherein the server assigns one or more selected content and one or more selected instructions to the intercept module based on an output of the algorithm; wherein the intercept module downloads the one or more content and the one or more instructions as the one or more content and the one or more instructions are updated; wherein the point of sale terminal sends one or more print commands to a printer after performing a transaction; wherein the intercept module is interconnected between the point of sale terminal and the printer, such that the intercept module emulates a functionality of the printer so as to receive the one or more print commands of the point of sale terminal; wherein the intercept module emulates the functionality of the point of sale terminal so that the printer will accept incoming print commands and send status information; wherein the intercept module intercepts and parses the print commands from the point of sale terminal; wherein the intercept module analyzes the one or more print commands, and inserts the one or more selected content based on the one or more print commands, such as items purchased (e.g., the IM reads that cereal was purchased so a coupon for milk was added in place of or in addition to content previously targeted for printing); wherein the intercept module alters the one or more print commands based on the one or more instructions and the one or more selected content and analysis of the one or more print commands; wherein the intercept module passes the one or more print commands to the printer for printing; and wherein said printer prints a receipt based on said one or more altered print commands The receipt may be comprised of: a transaction information; one or more business advertisements or coupons; and one or more network advertisements. The web application may allow the one or more users to create and edit the one or more content, such that the receipt is customizable to the one or more users. The web application may allow the one or more users to configure and customize the output of the intercept module. The web application may allow the one or more users to view, interact and exchange ads with one or more network nodes in an advertising exchange network; wherein the one or more network nodes comprise of at least one of the point of sale terminal and at least one of the intercept module. The intercept module may record and store the one or more print commands of the point of sale terminal and the one or more altered print commands received from the point of sale terminal.

Another embodiment of the present invention is an advertisement exchange network system, the network system comprising: a server; a database; a point of sale terminal; and an intercept module; wherein the server includes a web application; wherein the web application collects one or more instructions and one or more content from one or more users and updates the database with the one or more instructions and the one or more content; wherein the database stores the one or more instructions and one or more content; wherein an algorithm optimizes distribution of the one or more content across a network based on the one or more instructions and a metadata stored in the database; wherein the server assigns one or more selected content and one or more selected instructions to the intercept module based on an output of the algorithm; wherein the intercept module downloads the one or more selected content and the one or more selected instructions as the one or more selected content and the one or more selected instructions are updated; wherein the point of sale terminal sends one or more print commands to a printer after performing a transaction; wherein the intercept module is interconnected between the point of sale terminal and the printer, such that the intercept module emulates the functionality of the printer so as to receive the one or more print commands; wherein the intercept module emulates the functionality of the point of sale terminal so that the printer will accept the one or more incoming print commands and send a status information; wherein the intercept module intercepts and parses the one or more print commands from the point of sale terminal; wherein the intercept module selects one or more print commands to analyze and selects specific content to insert based on an analysis of an information received in the one or more print commands, such as items purchased (e.g., the intercept module reads that cereal was purchased so a coupon for milk was added in place of or in addition to content previously slated for printing); wherein the intercept module alters the one or more print commands based on the one or more selected instructions, the one or more selected content, and the analysis of the one or more print commands; wherein the intercept module creates a pre-printed image of a receipt; wherein the intercept module wirelessly transmits the pre-printed image to a mobile computing device; wherein the intercept module selectively passes the one or more print commands to the printer based on the one or more selected instructions; and wherein the pre-printed digital image is printed to create the receipt. The receipt is comprised of: transaction information; one or more business advertisements or coupons; and one or more network advertisements. The web application may allow the one or more users to create and edit the one or more content, such that the receipt is customizable to the one or more users. The web application may allow the one or more users to configure and customize the output of the intercept module. The web application may allow the one or more users to view, interact, and exchange one or more ads with one or more network nodes in an advertising exchange network; wherein the one or more network nodes are comprise of at least one of the point of sale terminal and at least one of the intercept module. The intercept module may record and may store both the one or more print commands of the point of sale terminal and the one or more altered print commands received from the point of sale terminal. The receipt may be distributed to one or more mobile computing devices and may not be forwared to the printer for printing. The receipt may be stored in a Cloud and may be provided via access through a QR code link.

Another embodiment of the present invention is an advertisement exchange network system, the network system comprising: a server; a database; a point of sale terminal; and a intercept module; wherein the server includes a web application; wherein the web application collects one or more instructions and one or more content from one or more users and updates the database with the one or more instructions and one or more content; wherein the database stores the one or more instructions and one or more content; wherein an algorithm optimizes content distribution across the network based on instructions and other metadata stored in the database; wherein the server assigns one or more content and one or more instructions to the intercept module based on the algorithm's output, wherein the intercept module download content and instructions as they are updated; wherein the point of sale terminal sends one or more print commands to a printer after performing a transaction; wherein the intercept module is interconnected between the point of sale terminal and the printer, such that the intercept module, emulates the functionality of the printer so as to receive print commands; wherein the intercept module emulates the functionality of the point of sale terminal so that the printer will accept incoming print commands and send status information; wherein the intercept module intercepts and parses the print commands from the point of sale terminal; wherein the intercept module may or may not analyze the print command, and may or may not insert specific content based on that analysis in the print command, (e.g., the intercept module reads that cereal was purchased so an advertisement for milk was added in place of or in addition to content previously slated for printing); wherein the intercept module alters the print command based on the instructions and content and or analysis of the print command; wherein the intercept module creates an image of the how the receipt would look if it were printed on the printer; wherein the intercept module uploads the image to the internet; where in the intercept module identifies the unique weblink to the digital receipt; wherein the intercept module appends the digital receipt's weblink, preferably in the form of a QR code, to the print command; where in the updated print command is passed to the printer; wherein the final receipt may be a digital copy, printed copy or both; where in the printer may only print a web link to the digital copy; wherein the receipt is comprised of: transaction information; one or more business advertisements or coupons; one or more network advertisement and a scannable weblink to a digital copy of the receipt. The web application may allow the one or more users to create and edit the one or more content, such that the receipt is customizable to the user. The web application may allow the one or more users to configure and customize the output of the intercept module. The web application may allow the one or more users to view, interact and exchange ads with one or more network nodes in an advertising exchange network; wherein the one or more network nodes comprise of at least one of the point of sale terminal and at least one of the intercept module. The intercept module may record and store both the original and altered print commands received from the point of sale.

Another embodiment of the present invention is an advertisement exchange network system, the network system comprising: a server; a database; a point of sale terminal; and a intercept module; wherein the server includes a web application; wherein the web application collects one or more instructions and one or more content from one or more users and updates the database with the one or more instructions and one or more content; wherein the database stores the one or more instructions and one or more content; wherein an algorithm optimizes content distribution across the network based on instructions and other metadata stored in the database; wherein the server assigns one or more content and one or more instructions to the intercept module based on the algorithm's output, wherein the intercept module downloads content and instructions as they are updated; wherein the point of sale terminal sends one or more print commands to a printer after performing a transaction; wherein the intercept module is interconnected between the point of sale terminal and the printer, such that the intercept module, emulates the functionality of the printer so as to receive print commands; wherein the intercept module emulates the functionality of the point of sale terminal so that the printer will accept incoming print commands and send status information; wherein the intercept module intercepts and parses the print commands from the point of sale terminal; wherein it stores all print commands, wherein the intercept module sends the stored print commands to server regularly; wherein the server analyzes print commands so as to extract information from the raw print data; wherein the server uses that information to update the instructions as necessary; wherein the intercept module uses the latest server instructions to insert content into the print command; wherein the intercept module may or may not analyze the print command originating from the point of sale, and may or may not insert specific content based on that analysis as well as the latest server instructions, (e.g., the intercept module reads that cereal was purchased, and understands the price of milk has dropped so a coupon for milk was added in place of or in addition to content previously slated for printing); wherein the intercept module alters the print command based on the instructions and content and or analysis of the print command; wherein the intercept module creates an image of the how the receipt would look if it were printed on the printer; wherein the intercept module uploads the image to the internet; where in the intercept module identifies the unique weblink to the digital receipt; wherein the intercept module appends the digital receipt's weblink, preferably in the form of a QR code, to the print command; where in the updated print command is passed to the printer; wherein the final receipt may be a digital copy, printed copy or both; where in the printer may only print a web link to the digital copy; wherein the receipt is comprised of: transaction information; one or more business advertisements or coupons; one or more network advertisement and a scanable weblink to a digital copy of the receipt. The web application may allow the one or more users to create and edit the one or more content, such that the receipt is customizable to the user. The web application may allow the one or more users to configure and customize the output of the intercept module. The web application may allow the one or more users to view, interact and exchange ads with one or more network nodes in an advertising exchange network; wherein the one or more network nodes comprise of at least one of the point of sale terminal and at least one of the intercept module. The intercept module may record and store both the original and altered print commands received from the point of sale.

It is an object of the present invention to provide an advertising infrastructure, system, and/or network for participants to create and publish advertisements (or any information) to other participants (or the customers of the other participants) on receipts, digital or printed, through the use of an intercept module (IM) while using a back end web application/web portal. The advertising exchange network preferably provides purchasers to receive, search for, retrieve, view and download digital copies of their receipt, so that the receipt, and thus, the advertisement or coupon, is accessible from any internet connection or Bluetooth, NFC, ibeacon or wifi enabled mobile device.

It is an object of the present invention to allow users to create or edit advertisements or coupons in real time. Receipt based advertisement is currently preprinted, and once a print job is performed, the advertisements cannot be changed. The present invention allows for the creation, alteration, and publication of the printed advertisement in real time.

It is an object of the present invention to provide a network of connected participants or users that exchange advertising information. The network preferably includes an IM, which is a device that interconnects between any devices issuing a printer command, such as a point of sale terminal such as an electronic cash register, and a printer or printing device. The present invention also preferably allows the exchange and customization of advertising information on receipts in a dynamic setting and in real time by other network participants through the web application.

It is an object of the present invention to provide a IM or device that tracks and stores the receipts and advertisements being printed by each store.

It is an object of the present invention to provide an advertising exchange network that utilizes a credit system in which stores are credited for the advertisements they display. For example, when a store prints an advertisement (or information of any type) for another store, the store printing the advertisement will be credited gaining the ability to have its ads printed elsewhere, likewise the store that's advertisement was printed will debited. The advertising exchange network will also receive ad inventory as well as monetary payments from users as compensation for creating the network.

It is an object of the present invention to provide receipt based advertising that is networked. Specifically, it is an object to provide a network of connected users or participants that allows members to swap advertising space and an infrastructure to allow participants to interact and cross-market each other.

It is an object of the present invention to provide an IM or device that is a standalone device that works with any and all point of sale terminals and printers. Preferably, the IM requires no additional software code or application added to the point of sale terminal.

It is an object of the present invention to provide an IM that will send copies of the print command back into the advertisement exchange network. Preferably, the users can search for, retrieve, view, and download copies of their receipt by making a copy of the receipt accessible from any Internet connection.

It is the object of the present invention to provide an IM that will distribute receipts to mobile computing devices as requested by the customer.

It is the object of the present invention to provide a Do It Yourself (DIY) advertising exchange network where customers can create and distribute ads in real time via a networked advertising infrastructure.

It is an object of the present invention to provide an advertisement exchange network that allows participants to exchange advertising information free of charge.

It is an object of the present invention to overcome the limitations of the prior art.

These as well as other components, steps, features, objects, benefits, and advantages, will now become clear from a review of the following detailed description of illustrative embodiments, the accompanying drawings, and the claims.

### BRIEF DESCRIPTION OF THE DRAWINGS

The drawings are of illustrative embodiments. They do not illustrate all embodiments. Other embodiments may be used in addition or instead. Details which may be apparent or unnecessary may be omitted to save space or for more effective illustration. Some embodiments may be practiced with additional components or steps and/or without all of the components or steps which are illustrated. When the same numeral appears in different drawings, it refers to the same or like components or steps.

FIG. 1 is a flow chart of one embodiment of the advertisement exchange network and shows the process flow of the advertisement exchange network.

FIG. 2 is a flow chart of one embodiment of the advertisement exchange network and shows two users exchanging advertisements and content over the advertisement exchange network.

FIG. 3 is a flow chart of one embodiment of the advertisement exchange network and shows the interconnections of multiple routers, point of sale terminals, servers, databases, and personnel of the advertisement exchange network.

FIG. 4 is an illustration of one embodiment of the web application of the advertisement exchange network and shows the configuration of the intercept module displayed to a user when using the web application.

FIG. 5 is an example of a test printout page of one embodiment of the web application of the advertisement exchange network.

FIG. 6 is an illustration of another embodiment of the web application of the advertisement exchange network and shows a template page when configuring a receipt.

FIG. 7 is an illustration of one embodiment of the web application of the advertisement exchange network and shows the functionality of adding content to the receipt.

### DETAILED DESCRIPTION OF THE DRAWINGS

In the following detailed description of various embodiments of the invention, numerous specific details are set forth in order to provide a thorough understanding of various aspects of one or more embodiments of the invention. However, one or more embodiments of the invention may be practiced without some or all of these specific details. In other instances, well-known methods, procedures, and/or components have not been described in detail so as not to unnecessarily obscure aspects of embodiments of the invention.

While multiple embodiments are disclosed, still other embodiments of the present invention will become apparent to those skilled in the art from the following detailed description, which shows and describes illustrative embodiments of the invention. As will be realized, the invention is capable of modifications in various obvious aspects, all without departing from the spirit and scope of the present invention. Accordingly, the graphs, figures, and the detailed descriptions thereof, are to be regarded as illustrative in nature and not restrictive. Also, the reference or non-reference to a particular embodiment of the invention shall not be interpreted to limit the scope of the invention.

In the following description, certain terminology is used to describe certain features of one or more embodiments of the invention. For instance, “point of sale terminal” typically refers to any electronic data processing unit where a transaction occurs in exchange for goods or services, including without limitation, a physical electronic cash register, dedicated point of sale hardware used for checkout, smartphone, tablet, laptop, and/or mobile point of sale device. The point of sale terminal may also refer to the location where the sale is conducted, money changes hands and a receipt is given. The term “electronic data processing unit” refers to any device that processes information with an integrated circuit chip, including without limitation, mainframe computers, work stations, servers, desktop computers, portable computers, laptop computers, telephones, smartphones, embedded computers, wireless devices including cellular phones, tablet computers, personal digital assistants, digital media players, portable game players, and hand-held computers. The terms “Internet” and “World-Wide-Web” refer to any collection of networks using standard protocols, whether Ethernet, ATM, FDDI, WI-FI, Token ring, or any combination thereof.

The terms “advertisement”, “advertising”, or “ad” generally refer to any form of communication for marketing that is used to inform, encourage, or persuade an audience to continue or take some new action with respect to a commercial offering. The term “coupon” generally refers to a ticket or document that can be exchanged for a financial discount or rebate when purchasing a product. The term “receipt” preferably refers to a written acknowledgment or electronic transmission such as an e-receipt that a specified article or sum of money has been received and usually records the purchase of goods or service obtained in exchange for the tendered funds.

The present invention is an advertising exchange network that preferably allows one or more participating users to print an advertisement of their own creation and/or additional information, at a participating business' point of sale. The advertisement exchange network typically utilizes an intercept module (IM) that interconnects between the printer and the point of sale system or device. Upon issuance of a print command by the point of sale device or terminal, the IM preferably intercepts the print command and generally modifies the print command to add advertising in the form of images, text, messages, coupons, barcodes, codes, or the like. The IM then preferably relays the new print command to the printer or mobile computing device which will print or display the receipt, advertisements, and any other pertinent information, as directed by the advertisement exchange network. The new information added to the receipt is preferably dynamic and is preferably added by the users, administrators or algorithms through a web application. A credit system may also be utilized to encourage advertising, exposure, and cross-advertising and equality to all the participating members.

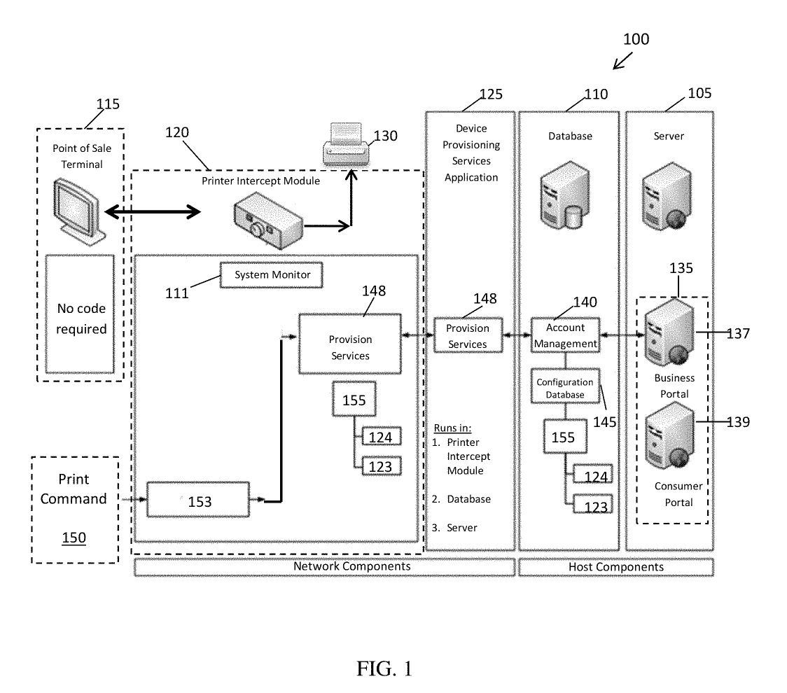

FIG. 1 is a flow chart of one embodiment of the advertisement exchange network and shows the process flow of the advertisement exchange network. As shown in FIG. 1, one embodiment of the advertisement exchange network 100 preferably includes: a server 105; database 110; point of sale terminal 115; intercept module (IM) 120; device provisioning services application 125; and printer 130. The server 105 is preferably a hardware configuration with a central processing unit that includes a web application 135 for providing users with a web portal (e.g., business portal 137 or consumer portal 139) to perform various functions for creating, editing, and downloading advertisements. Specifically, the web application 135 is preferably a front end hosted presence used to handle various account management functions and customer services such as viewing network nodes, creating an account, managing an account, ordering a IM, creating an advertisement, creating a campaign, and monitoring a campaign. The web application 135 also preferably provides information to users such as information regarding the advertisement exchange network 100 and its functionality. Furthermore, the server 105 preferably collects information from its users and generally updates the database 110 with the information. Such information preferably includes instructions 123 as to how to customize an advertisement and content 124, which is typically substantive information or creative material used for the advertisement (e.g., images, advertisements, coupons, receipts, dynamic advertisements, or any information). The database 110 is preferably any hardware or software configuration that stores, collects, and/or sends structured data including instructions 123 and content 124. The database 110 also allows one or more users to query or search such content via the device provisioning services application 125. The database 110 may include an account management 140, which typically is a portion of the database 110 that stores user accounts, and configuration database 145, which typically includes various configuration information of the IM 120. The device provisioning services application 125 is preferably a software application that queries the database 110 for instructions and creates/generates the intercept module commands (i.e., instructions read by the IM 120). The device provisioning services application 125 may utilize the provision services 148, a service process that typically provides operating instructions to and from the IM 120, database 110, and server 105, and is preferably installed onto the IM 120, database 110, and/or server 105. The device provisioning services application 125 also preferably provides data manipulation and configuration management for the IM 120 by controlling, deploying, and reporting to the IM 120. The IM 120 is preferably an embedded computing device that interconnects between a point of sale terminal 115 and printer 130 and preferably intercepts print commands from a point of sale system terminal 115. The IM 120 preferably sends outgoing print commands (i.e., intercept module commands) to the printer 130 and typically performs other various actions, including without limitation: (1) downloading the instructions from the database 110; (2) burning or storing content into the printer's 130 memory as needed; (3) receiving/intercepting and editing print commands sent from the point of sale terminal 115; (4) sending the intercept module commands to the printer 130; (5) storing and recording one or more incoming print commands from the point of sale terminal; (6) uploading print commands to the database 110; and (7) providing reports regarding the daily count of print commands received by the database 110. The IM 120 may also include a system monitor 111, which is typically a software process or service or hardware configuration that collects and stores data or information such as receipts, print commands, content, and intercept module commands within the advertisement exchange network 100. The printer 130 is typically any device that accepts any printer command language (PCL) involving texts, graphics, and intercept module commands from the IM 120, but may also receive PCLs from the server 105, database 110, device provisioning services application 125, or point of sale terminal 115. Preferably, the printer 130 receives the PCL information and transfers such information onto paper to produce receipts and/or advertisements. The point of sale terminal 115 is preferably any hardware or software configuration that performs transactions involving the exchange for goods or services and typically produces one or more print commands, which are typically sent to the printer 130 but intercepted by the IM 120. The point of sale terminal 115, for instance, may be a physical electronic cash register, dedicated point of sale hardware used for checkout, or a specially programmed wired or wirelessly connected computer. Although FIG. 1 shows the server 105, database 110, point of sale terminal 115, IM 120, and device provisioning services application 125 to be separate components of the advertisement exchange network 100, two or more of these components may be combined as a single component without deviating from the scope of the invention.

FIG. 1 also shows the preferred process flow of the advertisement exchange network 100. Typically, a user will login through the business portal 137 or consumer portal 139 of the web application 135 and will enter information to the advertisement exchange network 100 by inputting instructions 123 and/or content 124 (e.g., advertisements) onto the receipts. The web application 135 thereafter preferably collects instructions 123 from the user and typically updates the database 110 by storing the instructions 124 into the database 110. Other information such as content 124 (e.g., images, advertisements, coupons, etc . . . ), account information, and IM configuration may also be stored into the database 110. When a good or service transaction is typically made at the point of sale terminal 115, the point of sale terminal 115 preferably sends a print command 150 to the printer 130, and the print command 150 is preferably intercepted by the IM 120 via the intercept application 153 of the IM 120. Upon receipt of the print command 150 by the intercept application 153, the IM 120 typically utilizes the device provisioning services application 125 to analyze the print command 150 and preferably queries or searches the database 110 for one or more instructions 123 or content 124 relevant to the print command 150.

After gathering instructions 123 or content 124, the device provisioning services application 125 preferably creates/generates intercept module commands (“IM commands”), which are instructions that are read by the IM 120, and preferably sends the IM commands to the IM 120. Preferably, the IM 120 stores the IM commands for later printing or downloading, but may be immediately transferred to the printer 130 for printing. Typically, the instructions 123 and content 124 are transferred through physical mediums 155 such as serial, universal serial bus, or Ethernet ports, but may be transferred wirelessly via Bluetooth®, NFC, iBeacon® or WiFi®.

The advertisement exchange network 100 may also utilize a credit system. Specifically, the IM 120 may track advertisements being printed. Each time a user or business prints an advertisement (or information of any type) for another store, the store which originally printed the advertisement will preferably receive credit for displaying an ad while the advertisement exchange network 100 also receives credit for providing the infrastructure. However, it should be understood that any fraction or variation credit may be used to identify that a user has participated in the system.

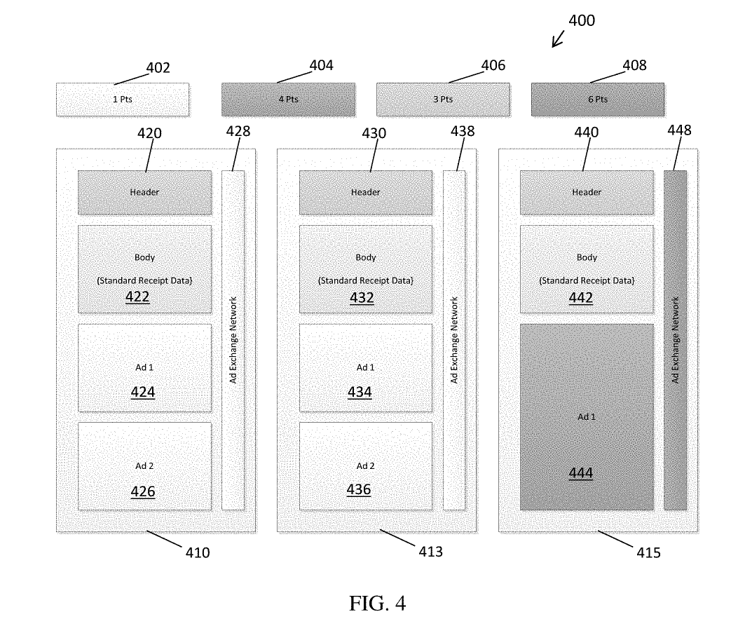

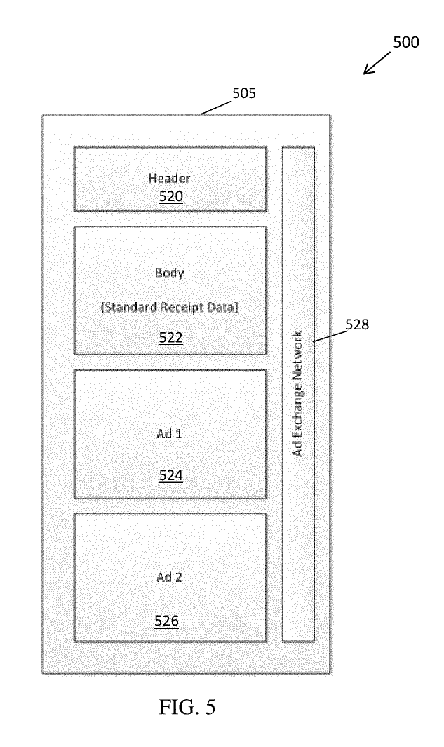

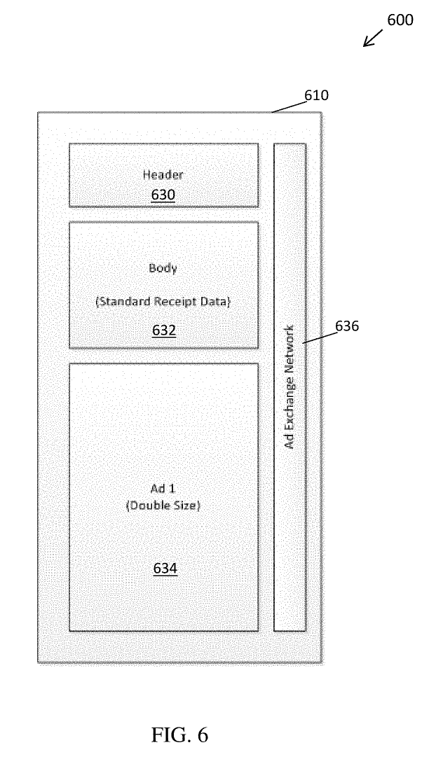

Regarding the web application 135, the web application 135 preferably includes: (1) a landing page; (2) how it works page; (3) explore the network page; (4) home page; (5) enrollment function (i.e., account settings); (6) intercept module configuration function (IM configuration function) (shown in FIGS. 4 and 5); (7) creating an advertisement function (shown in FIG. 6); (8) creating a campaign function; (9) account balance validation tool; (10) payment page; and (11) advertisement validation function. Specifically, the landing page is preferably the web page that displays the login menu where a user enters his or her username and/or password for login validation. If the incorrect username and/or password is inputted, the user may be redirected to the account reset page. The how it works page is preferably the web page that informs the user about how the advertisement exchange network 100 functions. The explore the network page is preferably the web page that shows a map with points of interests depicting network nodes (e.g., point of sales or searchable business addresses) of each user and is preferably searchable by the user. Specifically, the network nodes are preferably areas or locations on a geographic area which preferably shows participating members or users of the advertisement exchange network 100 and may typically comprise of at least one IM 120, point of sale terminal 115, and/or printer 130.

One embodiment of the web application may comprise a home page, which is generally the opening or main page of a website, intended to provide information about the advertisement exchange network 100 or its business owner. The home page may include a menu bar, which preferably provides links to other various areas of the web application 135 such as the advertisement library, campaign tool, equipment configuration, account settings page, and tutorial page. The advertisement library preferably provides a summary of existing advertisements along with options to create/delete/edit an advertisement. The campaign tool preferably provides the options to create, manage, and deploy campaigns (i.e., credits distribution) to the advertisement exchange network 100. The equipment configuration preferably provides the user with options to acquire a IM 120, validate the IM 120, install a new IM 120, decommission a IM 120 (i.e., remove a IM 120 from service), and repair and service a IM 120. The account settings page also preferably provides the user with: (1) account balance settings involving the credit system of the advertising exchange network 100; (2) store settings to view/reject/configure advertisements or ads queued in a store; (3) account information (e.g., name, contact, address); (4) billing information; and (5) password information. The tutorial page preferably provides the user with text and video information regarding the advertisement exchange network 100.

Regarding the enrollment function (i.e., account settings), the enrollment function preferably provides the user with options in enrolling with the advertisement exchange network 100 by preferably providing: (1) a login header; (2) forms and transaction information for purchasing a IM 120; and (3) background tasks as to creating an account.

Regarding the IM configuration function, the IM configuration function preferably includes configuration settings to connect and install the IM 120. Specifically, the user will typically login/sign into his or her account and generally access the IM installation instructions in the advertisement exchange network 100. After connecting the IM 120 to the point of sale terminal 115, printer 130, and internet, the IM 120 preferably prints a test printout page (i.e., test receipt) from the network. Once the IM 120 is properly installed, the user is typically prompted to launch into the receipt configuration tool (shown in FIG. 4) where the user preferably has options in: (1) selecting images and logos for the receipt header and receipt watermark; (2) configuring where, how, and how many advertisements will appear on the user's receipt; (3) adding various ads or advertisements such as header ads, banner ads, and trailer ads; and (4) viewing the distribution of credits for the advertisement exchange network 100.

Regarding creating an advertisement function, the creating an advertisement function preferably allows the user to select: (1) the size of his or her advertisement; (2) templates from publicly available advertisements, which typically include standard ads, double size ads, or banners; and (3) logo or standard image. The user also preferably has the option to add content of the ad or coupon to the template and other relevant information (e.g., telephone information, business hours information, and address information). There may be graphic areas that indicate the image will not be included onto the receipt (e.g., checkered areas), and the user may have a basic selection of fonts, font modifiers (e.g., bold, underline, italics), premium clip art, and watermarking. The user may also be informed of with a summary of coupon/advertisement impression costs such as the maximum number of receipt credits awarded per advertisement.

Regarding the creating a campaign function, the creating a campaign function preferably allows the user to browse the different network nodes, which, as discussed above, typically contain information about each participating user or store (e.g., competing stores, non-competing stores, and recommended stores). Under the creating a campaign function, the user may be able to view the different network nodes/stores and filter each store by type or proximity (preferably, the user will select three to five preferred locations for printing). The creating campaign tool may also include prompts to initiate action from a user (e.g., user prompts that state: “Your campaign is projected to print 100 ads/day. Double your daily exposure for just $x/day” or “Market to one of our exclusive members for an added cost of just $x/day”).

Regarding the account balance validation tool, the advertisement exchange network 100 may use an account balance validation tool to estimate the credits needed for a campaign based upon average advertisement counts for the stores printing advertisements. Specifically, the advertisement exchange network 100 preferably checks the user's accounts to determine whether sufficient credit exists to continue a campaign for a certain time period. If the account has insufficient credit to run a desired campaign or if the user desire greater repetition that what is offered, the user may be prompted to either purchase more credit at a given price or change the campaign advertisement count or run time. Alternatively, if the user desires to purchase more credit, the user may be given the option to do so via online banking such as Paypal® or credit card.

Regarding the payment page, the cost of each advertisement may be displayed to the user and may vary per location. Because the advertisement exchange network 100 is preferably free of charge for its advertising space, the cost of short term advertisements (e.g., advertisements printed today or tomorrow) may be reduced to the lowest acceptable amount. Preferably, the payment page will display the minimum quantity of advertisements, which preferably cannot be reduced, and also may allow the user to update the amount of advertisements that he or she would like to purchase. The payment page may also display the total of the transaction, method of payment, transaction confirmation, and credits given to the user.

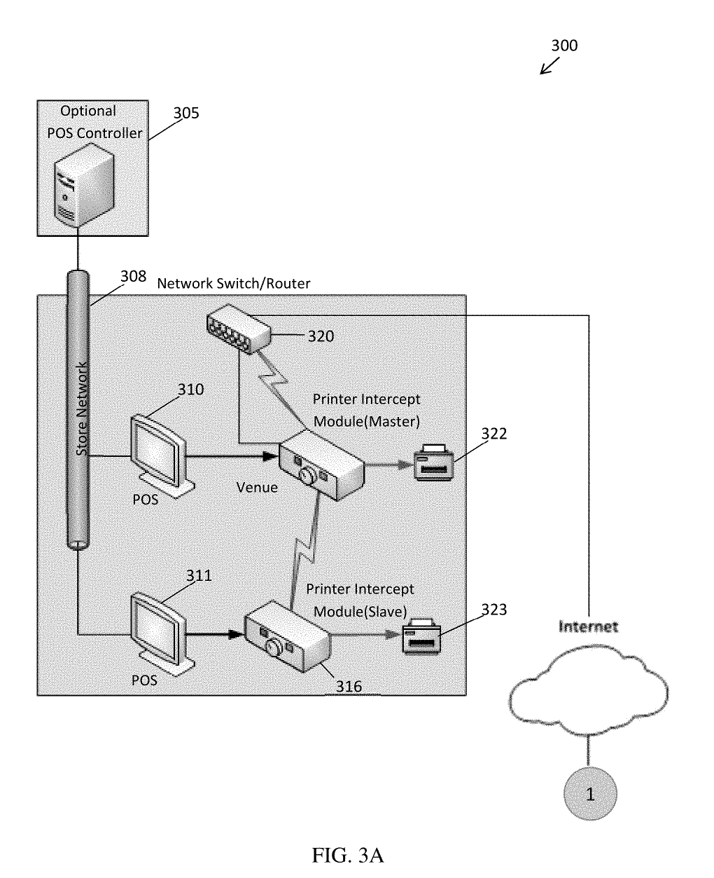

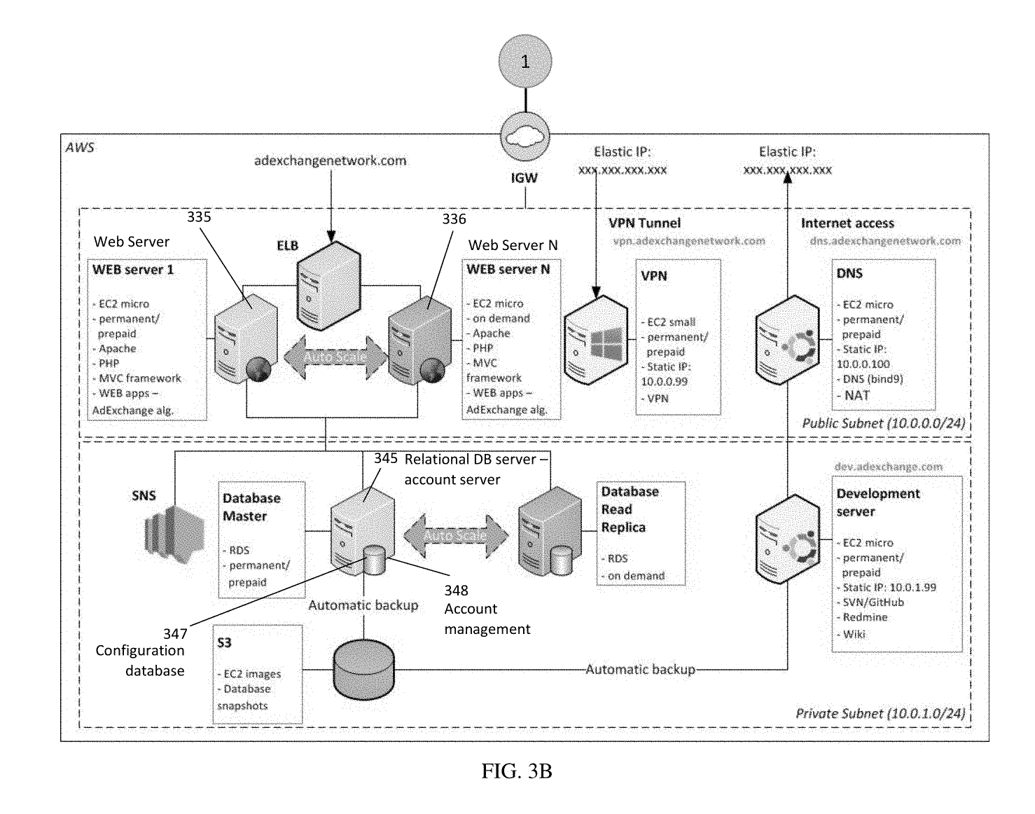

Regarding the advertisement validation function, the advertisement exchange network 100 preferably performs an automated check for any foul or offensive language or derivatives present in the user's advertisement. If any language matches with a dictionary's terms that refer to foul language, the advertisement is preferably not submitted. Preferably, the advertisement exchange network 100 will track and record the number of occurrences relating to the account in question, and may allow any administrator (shown in FIG. 3) to edit or alter the advertisement. Preferably, a copy of the advertisement will be emailed to all locations set to print the advertisement, and preferably the advertisement exchange network 100 will identify to the user when the new advertisement should print to the store. The advertisement validation function may also allow a user to also view and reject the advertisement.

The advertisement exchange network 100 will typically also include administrators. The administrator may have privileges on one or more accounts and will typically inherit all privileges on any account. Example of such privileges include: updating metadata or information on any account, adding credits to an account, debiting credits from an account, changing an account username, and changing an account password. Additionally, the administrator may be able to (1) view advertisements printed on any given day and advertisements submitted for review; (2) approve/reject advertisement for review, (3) view revenue that is generated by day, week, or month; (4) view total balance of an account; (5) update the IM 120 software remotely; (6) activate/deactivate IM 120 remotely; (7) stop printing at any location; (8) access any advertisements created in all accounts; (9) be apprised as to any malicious or suspicious behavior on behalf of any account; and (10) disable any account, if necessary.

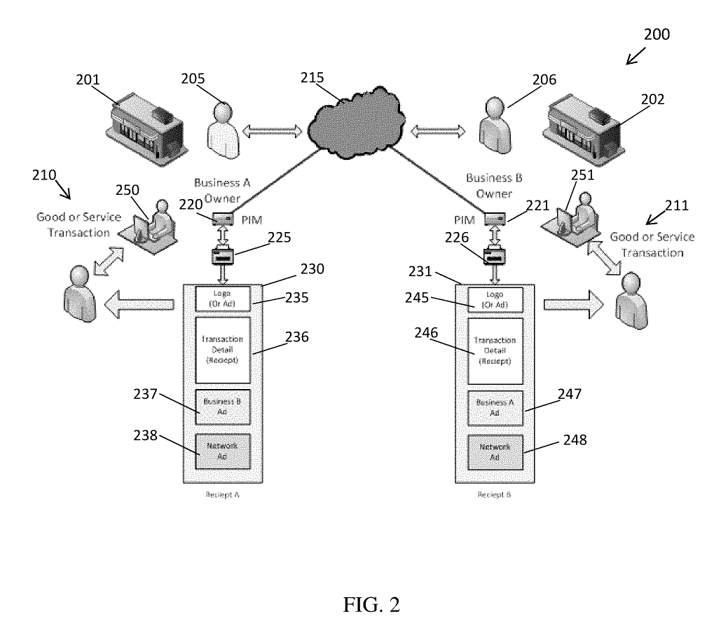

FIG. 2 is a flow chart of one embodiment of the advertisement exchange network and shows two users exchanging advertisements and content over the advertisement exchange network. As shown in FIG. 2, one embodiment of the advertisement exchange network 200 preferably includes: business A 201; business B 202; business A owner 205; business owner B 206; transaction A 210; transaction B 211; network 215; intercept module A (“IM A”) 220; intercept module B (“IM B”) 221; printers 225, 226; receipt A 230; and receipt B 231. Preferably, receipt A 230 may include: a logo 235, transaction detail 236, business B advertisement 237, and network advertisement 238. Preferably, the receipt B 231 may include: a logo 245, transaction detail 246, business A advertisement 247, and network advertisement 248. In this embodiment, IM A 220 and IM B 221 typically send copies of the print command 150 to the network 215 for storage. Network 215 preferably includes: server 105; database 110; and other components, as shown in FIG. 1. Users of the advertisement exchange network 200 can typically retrieve, view, and download a soft copy of their receipt online at any time or have a copy of the receipt sent directly to their mobile computing device. For example, as shown in FIG. 2, transaction A 210 is completed at point of sale terminal A 250 located at business A 201. Once transaction A 210 is completed, a print command 150 is typically sent to IM A 220 and is later sent and stored at the network 215. Similarly, when transaction B 211 is completed at point of sale terminal B 251 of business B 202, a print command 150 is generally sent to IM B 221 and is later sent to the network 215 for storage. Business owner A 205 who is preferably a user or participant of the advertisement exchange network 200 can typically customize in real time any receipts of other users of the advertisement exchange network 200 (which preferably includes business owner B 206). Business owner A 205 would typically be able to customize the logo 245, transaction detail 246, business A advertisement 247, and network advertisement 248. Similarly, like business owner A 205, business owner B 206 may be able to customize the logo 235, transaction detail 236, business B advertisement 237, and network advertisement 238. The receipts may be downloaded from the network 215 at any time for printing or for electronic storage. Although FIG. 2 shows the users to be physical companies, it should be understood that this invention may include online businesses as well.

FIG. 3 is a flow chart of one embodiment of the advertisement exchange network and shows the interconnections of multiple routers, point of sale terminals, servers, databases, and personnel of the advertisement exchange network. As shown in FIG. 3, one embodiment of the advertisement exchange network 300 preferably includes: point of sale controller 305; store network 308; point of sale terminals 310, 311; intercept modules 315, 316; router 320; printer 322, 323; Internet 330; servers 335, 336; business network 340; database 345; configuration database 347; account management database 348; firewall 350; and administrators 355. Generally, the point of sales controller 305, which is optional, is typically any hardware configuration that directs or regulates the point of sales terminals 310, 311 and is typically done through a store network 308. The intercept modules (IM) 315, 316, which are preferably interconnected between the point of sale terminals 310, 311 and printers 322, 323, may be connected to the Internet 330 via router 320 or switches. The IMs 315, 316 may be configured as a master/slave relationship, which is typically a communication protocol in which the master device (i.e., IM 315) controls one or more other slave devices (e.g., IM 316), such that the direction of control is preferably from the master to the slave(s). Additionally, the slave device may be an identical device as the master device and may function substantially similar as the master device. Although FIG. 3 shows a master/slave model, it should be understood that the present invention includes other communication protocol models as well such as the client/server model (i.e., server program responds to requests from a client program). The servers 335, 336 may be connected to the Internet 330 and business network 340, which is typically any collection of computers and other hardware interconnected by communication channels for the sharing of resources and information. The business network 340 may include a configuration database 347 and account management 348 and is preferably protected by a firewall 350 for the administrators 355.

In this embodiment, information may be downloaded from the Internet 330 to the IMs 315, 316 when a good or service transaction is made at the point of sale terminal 310, 311. The point of sale controller 305 preferably regulates the transactions at each point of sale terminal 310, 311, thereby regulating any outgoing print commands between the point of sale terminal 310, 311 and IMs 315, 316. Once the IMs 315, 316 intercept the outgoing print commands, the IMs 315, 316 preferably downloads instructions through the Internet 330 via the device provisioning services application. Administrators 355 may be used to maintain the servers 335, 336 and databases (e.g., configuration database 347; account management 348) to ensure that the advertisement network is running properly. Furthermore, administrators 355 will preferably have one or more administrative privileges, as discussed above.

FIG. 4 is an illustration of one embodiment of the web application of the advertisement exchange network and shows the configuration of the intercept module displayed to a user when using the web application. As shown in FIG. 4, the receipt configuration tool 400 of the web application 135 preferably includes: receipt credits 402, 404, 406, 408; configurations 410, 413, 415, receipt headers 420, 430, 440; transaction information 422, 432, 442; trailer advertisements 424, 426, 434, 436, 444; and banner advertisements 428, 438, 448. Preferably, after the user connects the IM 120 to the point of sale terminal 115, the advertisement exchange network 100, 200, 300 will preferably print a test printout page (shown in FIG. 5) from the advertisement exchange network100, 200, 300 rather than the point of sale terminal 115. After a test printout page is printed successfully, the web application 135 will preferably launch a screen that will typically configure the IM 120 and will preferably reveal several configurations 410, 413, 415. Specifically, the user typically selects an image/logo for their receipt header 420, 430, 440 if one is desired (i.e., header 420, 430, 440 of the transaction information 422, 432, 442). The user then should be typically provided with options on where, how, and how many advertisements will appear on their receipt. The user will be shown the default configuration (which may only be one or more transaction information 422, 432, 442 and one or more trailer advertisements 424, 426, 434, 436, 444) along with a preview of the configuration. Preferably, the user will have the option to add one or more of the following: header advertisements 420, 430, 440, banner advertisement 428, 438, 448, additional trailer advertisements 424, 426, 436, 434, 444, and the like. Furthermore, the user will preferably be shown the maximum number of receipt credits 402, 404, 406, 408 that can be earned with each configuration 410, 413, 415, and the user will preferably receive credits based upon the selection of each desired configuration.

FIG. 4 also shows the distribution of receipt credits awarded per advertisement. Credits are preferably distributed based upon the location of each advertisement and the number of advertisements. For example, FIG. 4 shows that when an advertisement is made at trailer advertisement 444, four credits are preferably distributed. Additionally, three credits is preferably distributed for the receipt headers 420, 430, 440 while one credit may be distributed for trailer advertisements 424, 426, 434, 436. Furthermore, one credit or six credits may be distributed for banner advertisements 428, 438, 448. Although FIG. 4 shows only four variations of receipt credits and three different configurations, it should be understood that any number of receipt credits, configurations, receipt headers, transaction information, trailer advertisements, and banner advertisements may be used without deviating from the scope of the invention.

FIG. 5 is an example of a test printout page of one embodiment of the web application of the advertisement exchange network. As shown in FIG. 5, the test printout page 500 preferably includes at least configuration 505. The configurations 505 may include: receipt headers 520; transaction information 522; trailer advertisement 524; and banner advertisement 528. Like the illustrations shown in FIG. 4, the receipt header 520 preferably contains image or logos of the user's businesses while the transaction information 522 is preferably information relating to the transaction made at the point of sale. The trailer advertisement 524 is preferably any form of marketing used to encourage a commercial offering, and the banner advertisement 528, web banner, or banner ads are preferably any form of advertising on the World Wide Web delivered by an advertising or ad server.

FIG. 6 is an illustration of another embodiment of the web application of the advertisement exchange network and shows a template page when configuring a receipt. As shown in FIG. 6, the creating an advertisement function 600 preferably includes a configuration 610. The configuration 610 may include: receipt header 630; transaction information 632; trailer advertisement 634; and banner advertisement 636. Like the test printout page 500 shown in FIG. 5, the receipt header 630 preferably contains image or logos of the company generating the receipt. The transaction information 632 is preferably information relating to the transaction made at the point of sale. The trailer advertisement 634 is preferably any form of marketing used to encourage a commercial offering. Like the test printout page 500, banner advertisement 636 web banner, or banner ads are preferably any form of advertising on the World Wide Web delivered by an advertising server.

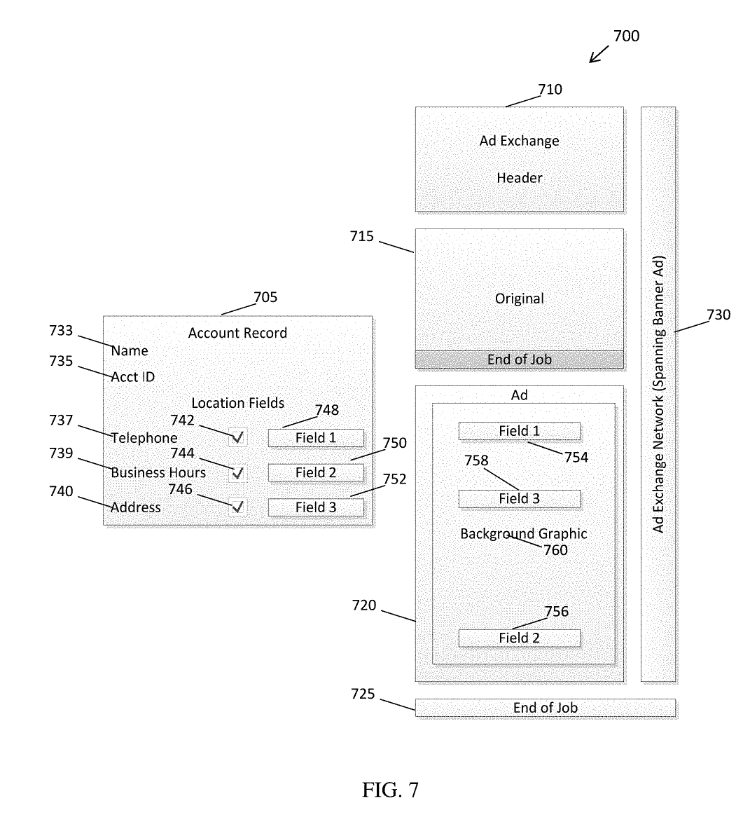

FIG. 7 is an illustration of one embodiment of the web application of the advertisement exchange network and shows the functionality of adding content to the receipt. As shown in FIG. 7, one embodiment of the web application 700 preferably includes: account record window 705; receipt header 710; transaction information 715; trailer advertisement 720; end of print job 725; and banner advertisement 730. The account record window 705 preferably includes: name 733; account identification number 735; telephone information 737; business hours information 739; address information 740; checkboxes 742, 744, 746; first field 748; second field 750; and third field 752. Preferably, the trailer advertisement 720 includes: first field 754; second field 756; third field 758; and background graphic 760. When a user adds content (e.g., advertisements, coupons, etc . . . ) to the receipt, the user will likely be prompted to enter information in the web application 700. Specifically, the user will typically be prompted to enter information in the account record window 705 such as the name 733 of the user or business; the account identification number 735 of the user; telephone information 737; business hours information 739; and address information 740. Preferably, the user will enter his or her telephone number in the first field 748; his or her business hours in the second field 750; and his or her address in the third field 758, and such information will typically be copied onto the first field 754, second field 756, and third field 758 of the trailer advertisement 720. The checkboxes 742, 744, 746 may also be used to disable or enable the transfer of such information onto the receipt. The background graphic 760 is any image, graphic picture, or logo that may be placed within the trailer advertisement 720. The end of print job 725 preferably indicates when the print job of printing the receipt is completed. Although FIG. 7 shows the telephone information, business hours information, and address information in the trailer advertisement field, it should be understood that such information may be placed anywhere in the receipt such as the receipt header, transaction information, and end of job. Furthermore, any additional or subset of the information may be added onto the receipt without deviating from the scope of the invention.

Unless otherwise stated, all measurements, values, ratings, positions, magnitudes, sizes, locations, and other specifications which are set forth in this specification, including in the claims which follow, are approximate, not exact. They are intended to have a reasonable range which is consistent with the functions to which they relate and with what is customary in the art to which they pertain.

Except as stated immediately above, nothing which has been stated or illustrated is intended or should be interpreted to cause a dedication of any component, step, feature, object, benefit, advantage, or equivalent to the public, regardless of whether it is or is not recited in the claims.

What is claimed is:

1. An advertisement exchange network system, the network system comprising:
a server;
a database;
a point of sale terminal; and
an intercept module;
wherein said server includes a web application;
wherein said web application collects one or more instructions and one or more content from one or more users and updates said database with said one or more instructions and said one or more content;
wherein said database stores said one or more instructions and said one or more content;
wherein an algorithm optimizes distribution of said one or more content across a network based on said one or more instructions and a metadata stored in said database;
wherein said server assigns one or more selected content and one or more selected instructions to said intercept module based on an output of said algorithm;
wherein said intercept module downloads said one or more selected content and said one or more selected instructions as said one or more content and said one or more instructions are updated;
wherein said point of sale terminal sends one or more print commands to a printer after performing a transaction;
wherein said intercept module is interconnected between said point of sale terminal and said printer, such that said intercept module emulates the functionality of the printer to receive said one or more print commands of said point of sale terminal;
wherein said intercept module emulates the functionality of said point of sale terminal so that said printer will accept one or more incoming print commands and send a status information;
wherein said intercept module intercepts and parses said one or more print commands from said point of sale terminal;
wherein the intercept module alters said one or more print commands based on said one or more selected instructions and one or more selected content said intercept module received from said server;
wherein said intercept module passes said one or more altered print commands to said printer; and
wherein said printer prints a receipt based on said one or more altered print commands

2. The advertisement exchange network system of claim 1, wherein said receipt comprises: a transaction information; one or more business advertisements; and one or more network advertisements.

3. The advertisement exchange network system of claim 1, wherein said web application allows said one or more users to create and edit said one or more content, such that said receipt is customizable to said one or more users.

4. The advertisement exchange network system of claim 1, wherein said web application allows said one or more users to configure and customize said output of said intercept module.

5. The advertisement exchange network system of claim 1, wherein said web application allows said one or more users to view, interact, and exchange ads with one or more network nodes in an advertising exchange network;
wherein said one or more network nodes comprises: at least one of said point of sale terminal and at least one of said intercept module.

6. The advertisement exchange network system of claim 1, wherein said intercept module records and stores both said one or more print commands received from said point of sale terminal and said one or more altered print commands

7. The advertisement exchange network system of claim 1, wherein said intercept module redirects said one or more print commands of said point of sale terminal and said one or more altered print commands to another output medium.

8. An advertisement exchange network system, the network system comprising:
a server;
a database;
a point of sale terminal; and
an intercept module;
wherein said server includes a web application;
wherein said web application collects one or more instructions and one or more content from one or more users and updates said database with said one or more instructions and one or more content;
wherein said database stores said one or more instructions and one or more content;
wherein an algorithm optimizes distribution of said one or more content across a network based on said one or more instructions and a metadata stored in said database;
wherein said server assigns one or more selected content and one or more selected instructions to said intercept module based on an output of said algorithm;
wherein said intercept module downloads said one or more selected content and said one or more selected instructions as said one or more content and said one or more instructions are updated;
wherein said point of sale terminal sends one or more print commands to a printer after performing a transaction;
wherein said intercept module is interconnected between said point of sale terminal and said printer, such that said intercept module emulates a functionality of said printer so as to receive said one or more print commands of said point of sale terminal;
wherein said intercept module emulates the functionality of said point of sale terminal so that said printer will accept said one or more print commands and send a status information;
wherein said intercept module intercepts and parses said one or more print commands from said point of said terminal;
wherein said intercept module analyzes said one or more print commands and inserts said one or more selected content based on said one or more print commands;
wherein said intercept module alters said one or more print commands based on said one or more selected instructions, said one or more selected content, and said analysis of said one or more print commands;
wherein said intercept module passes said one or more altered print commands to said printer for printing; and
wherein said printer prints a receipt based on said one or more altered print commands.

9. The advertisement exchange network system of claim 8, wherein said receipt is comprised of: a transaction information; one or more business advertisements; and one or more network advertisements.

10. The advertisement exchange network system of claim 9, wherein said web application allows said one or more users to create and edit said one or more content, such that said receipt is customizable to the one or more users.

11. The advertisement exchange network system of claim 10, wherein said web application allows said one or more users to configure and customize said output of said intercept module;
wherein said web application allows the one or more users to view, interact, and exchange ads with one or more network nodes in an advertising exchange network; and
wherein the one or more network nodes are comprised of at least one of said point of sale terminal and at least one of said intercept module.

12. The advertisement exchange network system of claim 11, wherein said intercept module records and stores both said one or more print commands of said point of sale terminal and said one or more altered print commands.

13. An advertisement exchange network system, the network system comprising:
a server;
a database;
a point of sale terminal; and
an intercept module;
wherein said server includes a web application;
wherein said web application collects one or more instructions and one or more content from one or more users and updates said database with said one or more instructions and one or more content;
wherein said database stores said one or more instructions and said one or more content;
wherein an algorithm optimizes distribution of said one or more content across a network based on said one or more instructions and a metadata stored in said database;
wherein said server assigns one or more selected content and said one or more selected instructions to said intercept module based on an output of said algorithm;
wherein said intercept module downloads said one or more selected content and said one or more selected instructions as said one or more content and said one or more instructions are updated;
wherein said point of sale terminal sends one or more print commands to a printer after performing a transaction;
wherein said intercept module is interconnected between said point of sale terminal and said printer, such that the intercept module emulates the functionality of the printer so as to receive said one or more print commands;
wherein said intercept module emulates the functionality of said point of sale terminal so that said printer will accept incoming said one or more print commands and send a status information;
wherein said intercept module intercepts and parses said one or more print commands from said point of sale terminal;
wherein said intercept module selects said one or more print commands to analyze and selects said one or more selected content to insert based on an analysis of an information received in said one or more print commands;
wherein said intercept module creates a pre-printed digital image of a receipt;
wherein said intercept module wirelessly transmits said pre-printed digital image to a mobile computing device;
wherein said intercept module selectively passes said one or more print commands to said printer based on said one or more selected instructions;
wherein said printer prints said pre-printed digital image to create a receipt.

14. The advertisement exchange network system of claim 13, wherein said receipt comprises: a transaction information; one or more business advertisements; and one or more network advertisements.

15. The advertisement exchange network system of claim 13, wherein said web application allows said one or more users to create and edit said one or more content, such that said receipt is customizable to said one or more users.

16. The advertisement exchange network system of claim 13, wherein said web application allows said one or more users to configure and customize said output of said intercept module.

17. The advertisement exchange network system of claim 13, wherein said web application allows said one or more users to view, interact, and exchange one or more ads with one or more network nodes in an advertising exchange network; and
wherein said one or more network nodes are comprised of at least one of said point of sale terminal and at least one of said intercept module.

18. The advertisement exchange network system of claim 13, wherein said intercept module records and stores both said one or more print commands received from said point of sale terminal and said one or more altered print commands.

19. The advertisement exchange network system of claim 13, wherein said receipt is distributed to one or more mobile computing devices.

20. The advertisement exchange network system of claim 13, wherein said receipt is stored in a Cloud and is provided via access through a QR code link.
